(19) United States
(12) Patent Application Publication
(10) Pub. No.: US 2024/0323863 A1
(43) Pub. Date: Sep. 26, 2024

(54) METHOD OF OPERATING CENTRAL CONTROL DEVICE, COMMUNICATION SYSTEM, AND METHOD OF OPERATING COMMUNICATION SYSTEM

(71) Applicant: SAMSUNG ELECTRONICS CO., LTD., Suwon-si (KR)

(72) Inventors: Junil Choi, Daejeon (KR); In-soo Kim, Daejeon (KR)

(73) Assignees: SAMSUNG ELECTRONICS CO., LTD., Suwon-si (KR); KOREA ADVANCED INSTITUTE OF SCIENCE AND TECHNOLOGY, Daejeon (KR)

(21) Appl. No.: 18/614,356

(22) Filed: Mar. 22, 2024

(30) Foreign Application Priority Data
Mar. 24, 2023 (KR) 10-2023-0039026

(51) Int. Cl. H04W 52/26; H04B 7/0452; H04W 52/36

(52) U.S. Cl. CPC H04W 52/267; H04B 7/0452; H04W 52/367

(57) ABSTRACT

Provided is a method of operating a central control device for generating a transmission signal to be transmitted to a plurality of user equipment through a plurality of base stations, the method including calculating a transmission power coefficient and a codebook parameter, such that a minimum value of a data rate of each of the plurality of user equipment is maximized, and a transmission power of the plurality of base stations is less than or equal to a transmission power limit and satisfies a fronthaul capacity limit, generating, by the central control device, a transmission signal based on the transmission power coefficient, and transmitting, by the central control device, the transmission signal to the plurality of base stations through a fronthaul.

### CROSS-REFERENCE TO RELATED APPLICATIONS

This application is based on and claims priority under 35 U.S.C. § 119 to Korean Patent Application No. 10-2023-0039026, filed on Mar. 24, 2023, in the Korean Intellectual Property Office, the disclosure of which is incorporated by reference herein in its entirety.

### BACKGROUND

### 1. Field

The disclosure relates to a method and an apparatus in a communication system, and in particular, a control device and a method of operating the control device in a communication system to transmit data to a user device at a high data rate.

### 2. Description of Related Art

In communication systems, a Multiple-Input Multiple-Output (MIMO) technology is used for spatially multiplexing and transmitting information according to instantaneous channels generated from a plurality of transmission and reception antennas. By using the MIMO technology, a plurality of data streams may be spatially multiplexed and transmitted through one time and frequency resource, and thus the data rate may be increased several times as compared to a related art non-MIMO transmission.

Recently, massive MIMO technology is implemented in a communication systems. For example, the massive MIMO technology installs and uses a plurality of antennas in a base station. By using the massive MIMO technology, it is possible to solve various problems that limit system performance, e.g., fast fading and inter-user interference (IUI). Various methods are being developed to provide high data rates to user equipment on the downlink when using the massive MIMO technology.

### SUMMARY

The disclosure provides a control device and a method of operating the control device to facilitate transmission of data to a user device at a high data rate.

According to an aspect of the disclosure, there is provided a method of operating a control device, the method including: obtaining a transmission power coefficient and a codebook parameter based on a data rate of each of a plurality of user equipment, a transmission power of a plurality of base stations and a fronthaul capacity limit; generating a transmission signal based on the transmission power coefficient; and transmitting the transmission signal to the plurality of base stations through a fronthaul.

According to another aspect of the disclosure, there is provided a control device including: at least one memory storing one or more instructions; and at least one processor configured to execute the one or more instructions: obtain a transmission power coefficient and a codebook parameter based on a data rate of each of a plurality of user equipment, a transmission power of a plurality of base stations and a fronthaul capacity limit; generate a transmission signal based on the transmission power coefficient; and transmit the transmission signal to the plurality of base stations through a fronthaul.

According to another aspect of the disclosure, there is provided a method of operating a communication system including a central control device, a fronthaul, and a plurality of base stations, the method including: obtaining, by the central control device, a transmission power coefficient and a codebook parameter based on a data rate of each of a plurality of user equipment is maximized, a transmission power of the plurality of base stations and a fronthaul capacity limit; generating, by the central control device, a transmission signal based on the transmission power coefficient; transmitting, by the central control device, the transmission signal to the plurality of base stations through the fronthaul generating fronthaul noise corresponding to the codebook parameter; quantizing, by each of the plurality of base stations, the transmission signal received through the fronthaul; and transmitting, by the plurality of base stations, the quantized transmission signal to the plurality of user equipment, respectively.

### BRIEF DESCRIPTION OF DRAWINGS

Embodiments of the disclosure will be more clearly understood from the following detailed description taken in conjunction with the accompanying drawings in which:

FIG. 1 is a conceptual diagram showing a communication system according to an embodiment;

FIG. 2 is a block diagram showing a communication system according to an embodiment;

FIG. 3 is a flowchart of a method of operating a central control device, according to an embodiment;

FIG. 4 is a flowchart of a method of calculating a transmission power coefficient and a codebook parameter according to an embodiment;

FIG. 5 is a flowchart of a first example of a method of determining whether a transmission power coefficient and a codebook parameter need to be re-calculated, according to an embodiment;

FIG. 6 is a flowchart of a second example of a method of determining whether a transmission power coefficient and a codebook parameter need to be re-calculated, according to an embodiment;

FIG. 7 is a flowchart of a third example of a method of determining whether a transmission power coefficient and a codebook parameter need to be re-calculated, according to an embodiment;

FIG. 8 is a flowchart of a method of operating a communication system, according to an embodiment; and

FIG. 9 is a block diagram showing a central control device according to an embodiment.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, in an example in which a component is described as being “connected to,” or “coupled to” another component, it may be directly “connected to,” or “coupled to” the other component, or there may be one or more other components intervening therebetween. In contrast, in an example in which an element is described as being “directly connected to,” or “directly coupled to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment (e.g., as to what an example or embodiment may include or implement) means that at least one example or embodiment exists where such a feature is included or implemented, while all example embodiments are not limited thereto.

The embodiments of the disclosure are example embodiments, and thus, the disclosure is not limited thereto and may be realized in various other forms. As is traditional in the field, embodiments may be described and illustrated in terms of blocks, as shown in the drawings, which carry out a described function or functions. These blocks, which may be referred to herein as units or modules or the like, or by names such as device, logic, circuit, counter, comparator, generator, converter, names ending in “˜or” or the like, may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

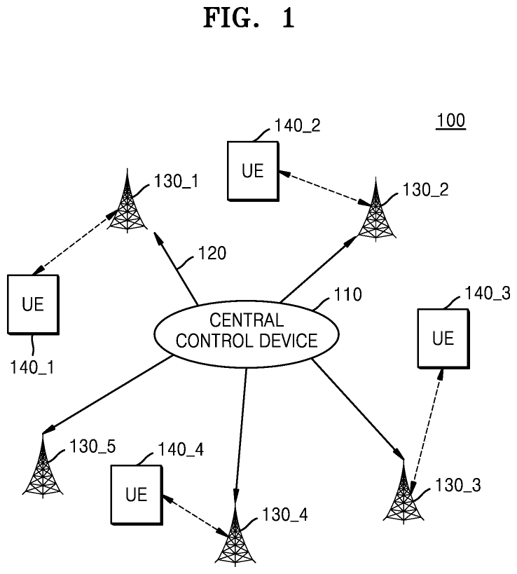

FIG. 1 is a conceptual diagram showing a communication system according to an embodiment.

Referring to FIG. 1, a communication system 100 according to an embodiment may be a cell-free massive Multiple-Input Multiple-Output (MIMO) communication system. A cell-free massive MIMO communication system is a system for providing a same performance to all users by installing multiple base stations throughout a wide area. The cell-free massive MIMO communication system may be one of distributed antenna technologies.

The communication system 100 according to an embodiment may include a control device 110, a fronthaul 120, a plurality of base stations 130_1 to 130_5, and a plurality of user equipment (UEs) 140_1 to 140_4. Hereinafter, the control device 110 may be referred to as a central control device 110. However, the disclosure is not limited thereto, and as such, the central control device 110 may be referred to as a control unit, a central unit, a central processor, etc. Although FIG. 1 shows an embodiment in which five base stations and four UEs are included in the communication system 100, the disclosure is not limited thereto. As such, according to another embodiment, a number of base station may be different than five and/or a number of UEs may be different from four.

The central control device 110 may support or control an operation in which the plurality of base stations 130_1 to 130_5 provide services to the plurality of UE 140_1 to 140_4. For example, the plurality of base stations 130_1 to 130_5 provide services to the plurality of UE 140_1 to 140_4 through cooperative communication under the control of the central control device 110.

The central control device 110 may be connected to the plurality of base stations 130_1 to 130_5 through the fronthaul 120. The central control device 110 may provide services to the plurality of UE 140_1 to 140_4 through the plurality of base stations 130_1 to 130_5 connected through the fronthaul 120.

In an example in which the central control device 110 is to transmit data to the plurality of UE 140_1 to 140_4, the central control device 110 may transmit the data to the plurality of base stations 130_1 to 130_5 connected through the fronthaul 120. For example, the central control device 110 may generate a transmission signal including the data to be transmitted to the plurality of UE 140_1 to 140_4. Next, the central control device 110 may transmit the data to the plurality of base stations 130_1 to 130_5 connected through the fronthaul 120, by using the generated transmission signal.

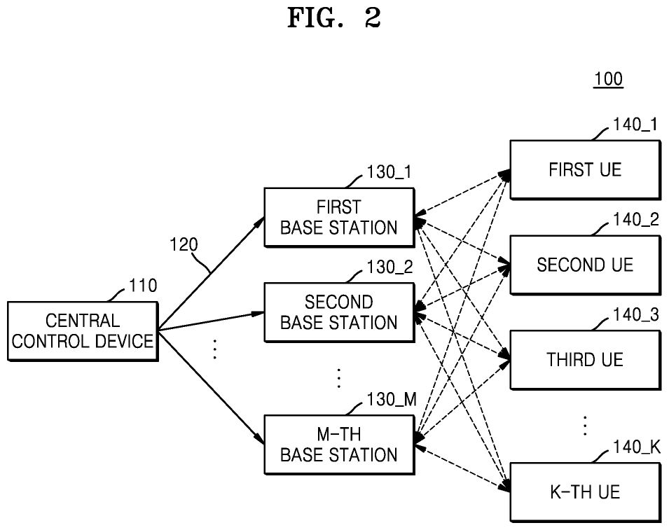

According to an embodiment, the central control device 110 may calculate a transmission power coefficient and a codebook parameter and generate a transmission signal based on the transmission power coefficient. According to an embodiment, the transmission power coefficient and the codebook parameter calculated by maximizing the minimum data rate of each of the plurality of UE 140_1 to 140_4 and limiting the transmission power of the plurality of base stations 130_1 to 130_5 to be less than or equal to a transmission power limit and satisfy a fronthaul capacity limit. According to an embodiment, the transmission power limit may be a power limit of the plurality of base stations 130_1 to 130_5. According to an embodiment, the transmission power may satisfy the fronthaul capacity limit if the transmission power is less than or equal to the fronthaul capacity limit. The operation of the central control device 110 will be described below in more detail with reference to FIG. 2 and subsequent drawings.

The fronthaul 120 may be a path interconnecting the central control device 110 and the plurality of base stations 130_1 to 130_5. The fronthaul 120 may transmit a transmission signal generated by the central control device 110 to the plurality of base stations 130_1 to 130_5. The fronthaul 120 may have a fronthaul capacity limit, which is a capacity limit of a signal transmitted through the fronthaul 120. For example, the fronthaul capacity limit may be C bps/Hz.

According to an embodiment, the plurality of base stations 130_1 to 130_5 may be refer to fixed stations communicating with the plurality of UE 140_1 to 140_4 and other base stations. The plurality of base stations 130_1 to 130_5 may exchange data and control information with the plurality of UE 140_1 to 140_4 and other base stations through the communication network. The plurality of base stations 130_1 to 130_5 may also be referred to as Nodes B, an evolved-Nodes B (eNB), Base Transceiver Systems (BTS), and Access Points (AP).

According to an embodiment, each of the plurality of base stations 130_1 to 130_5 may be connected to the central control device 110 through the fronthaul 120. According to an embodiment, each of the plurality of base stations 130_1 to 130_5 may provide services to the plurality of UE 140_1 to 140_4 through cooperation with one or more other base stations. For example, a first base station, among the plurality of base stations 130_1 to 130_5, may provide a service to one of the plurality of UE 140_1 to 140_4 through cooperation with a second base station, among the plurality of base stations 130_1 to 130_5.

According to an embodiment, the plurality of base stations 130_1 to 130_5 may receive a transmission signal through the fronthaul 120. The plurality of base stations 130_1 to 130_5 may quantize a received transmission signal. The plurality of base stations 130_1 to 130_5 may transmit a quantized transmission signal to the plurality of UE 140_1 to 140_4. The operation of the plurality of base stations 130_1 to 130_5 will be described below in more detail with reference to FIG. 2 and subsequent drawings.

The plurality of UE 140_1 to 140_4 are devices capable of wireless communication. The plurality of UE 140_1 to 140_4 may be stationary or mobile, and may be any one of various devices capable of transmitting and receiving data and control information by communicating with the plurality of base stations 130_1 to 130_5. The plurality of UE 140_1 to 140_4 may be referred to as a terminal, a terminal equipment, a mobile station (MS), a mobile terminal (MT), a user terminal (UT), a subscriber station, a wireless device, a handheld device, a smart phone, a wearable device, etc.

The plurality of UE 140_1 to 140_4 may each communicate with any one of the plurality of base stations 130_1 to 130_5. According to an embodiment, a first UE 140_1 may wirelessly communicate with a first base station 130_1 as indicated by a dashed line. However, the disclosure is not limited thereto, and as such, according to another embodiment, the first UE 140_1 may communicate with one or more of second to fifth base stations 130_2 to 130_5. For example, the first UE 140_1 may communicate with more than one base station.

A wireless communication network between the plurality of base stations 130_1 to 130_5 and the plurality of UE 140_1 to 140_4 may support communication of multiple users by sharing available network resources. For example, in a wireless communication network, information may be transmitted in various multiple connection schemes like code division multiple access (CDMA), frequency division multiple access (FDMA), time division multiple access (TDMA), orthogonal frequency division multiple access (OFDMA), single carrier frequency division multiple access (SC-FDMA), etc.

FIG. 2 is a block diagram showing a communication system according to an embodiment.

Referring to FIG. 2, the communication system 100 according to an embodiment may include the central control device 110, the fronthaul 120, a plurality of base stations 130_1 to 130_M (M is a natural number equal to or greater than 2), and a plurality of UE 140_1 to 140_K (K is a natural number equal to or greater than 2).

The central control device 110 may generate a transmission signal. The transmission signal is a signal to be transmitted from the central control device 110 to the plurality of base stations 130_1 to 130_M and may include a data signal representing data to be transmitted to the plurality of UE 140_1 to 140_K.

A transmission signal transmitted from the central control device 110 to each of the plurality of base stations 130_1 to 130_M through the fronthaul 120 may be expressed as Equation 1 below.

$${p}_{m} = {\sum }_{k = 1}^{K} {f}_{m , k} \sqrt{{η}_{m , k}} {s}_{k} \qquad [ Equation 1 ]$$

In Equation 1, pₘ may denote a transmission signal to be transmitted to an m-th base station (m is a natural number equal to or greater than 1 and smaller than or equal to M), fₘ,k may denote a linear precoder matrix representing linear precoders between the m-th base station and a k-th UE (k is a natural number equal to or greater than 1 and smaller than or equal to K), ηₘ,k may denote a transmission power coefficient corresponding to the transmission power used for transmission of a transmission signal from the m-th base station to the k-th UE, and sₖ may denote a data representing data to be transmitted to the k-th UE. According to an embodiment, the linear precoder matrix fₘ,k and the data signal sₖ may have pre-set fixed values. Accordingly, a transmission signal may be generated based on the transmission power coefficient ηₘ,k.

According to an embodiment, the central control device 110 may calculate a transmission power coefficient and a codebook parameter to maximize the minimum data rate of each of the plurality of UE 140_1 to 140_K and limit the transmission power of the plurality of base stations 130_1 to 130_M to be less than or equal to a transmission power limit and satisfy a fronthaul capacity limit.

First, the fronthaul capacity limit may be expressed as Equation 2 below.

$${C}_{m} = I ( {p}_{m} ; {p}_{m} + {d}_{m} ) = {log}_{2} det ( I + \frac{1}{{σ}_{m}^{2}} {\sum }_{k = 1}^{K} {f}_{m , k} {f}_{m , k}^{H} {η}_{m , k} ) \leq C \qquad [ Equation 2 ]$$

In Equation 2, Cₘ may denote the fronthaul capacity, dₘ may denote the fronthaul noise generated during transmission of a signal through the fronthaul 120, I(pₘ; pₘ+dₘ) may denote an amount of mutual information between a transmission signal pₘ and a value pₘ+dₘ obtained by adding the fronthaul noise to the transmission signal pₘ, I may denote a unit matrix, σₘ may denote a codebook parameter indicating the type of a codebook used for compression of the transmission signal pₘ for transmission of the transmission signal pₘ through the fronthaul 120, and C may indicate the fronthaul capacity limit. Here, the codebook parameter σₘ is a value to be calculated by the central control device 110 together with the transmission power coefficient.

Next, the condition that the transmission power is equal to or less than the transmission power limit may be expressed as Equation 3 below.

$${P}_{m} = E \{ {‖ {x}_{m} ‖}^{2} \} \leq P \qquad [ Equation 3 ]$$

In Equation 3, Pₘ may denote the transmission power, xₘ may denote a quantized transmission signal generated by quantizing a transmission signal received from the m-th base station, and P may denote the transmission power limit.

Here, the quantized transmission signal xₘ may be expressed as Equation 4 below.

$${x}_{m} = {W}_{m} Q ( {p}_{m} + {d}_{m} ) \qquad [ Equation 4 ]$$

In Equation 4, Wm may denote an analog precoder matrix representing the analog precoder of the m-th base station, and Q(pₘ+dₘ) may denote a quantization function of a value (pₘ+dₘ) obtained by adding the fronthaul noise to a transmission signal. Here, the quantization function may be a function representing an additive quantization noise model, and, through this, Equation 4 may be expressed as Equation 5 below.

$$[ Equation 5 ]$$

$${x}_{m} = {W}_{m} ( ( 1 - ρ ) ( {\sum }_{k = 1}^{K} {f}_{m , k} \sqrt{{η}_{m , k}} {s}_{k} + {d}_{m} ) + {\overline{q}}_{m} ) = {W}_{m} ( {\sum }_{k = 1}^{K} ( 1 - ρ ) {f}_{m , k} \sqrt{{η}_{m , k}} {s}_{k} + {q}_{m} )$$

In Equation 5, p may denote a value corresponding to the number of bits of the quantization function, q̅ₘ may denote the quantization noise having zero correlation with respect to a data signal sₖ and a fronthaul noise dₘ, and qₘ may denote a noise obtained by summing the quantization noise (q̅ₘ) and the fronthaul noise dₘ.

Finally, the data rate of each of the plurality of UE 140_1 to 140_K may be expressed as Equation 6 below.

$${D}_{k} = {log}_{2} ( 1 + \frac{{( 1 - ρ )}^{2} {η}_{k}}{{h}_{k}^{H} {C}_{q} {h}_{k} + {σ}^{2}} ) = {log}_{2} ( 1 + SIN {R}_{k} ) \qquad [ Equation 6 ]$$

In Equation 6, Dₖ may denote the data rate of the k-th UE, ηₖ may denote the transmission power coefficient of a transmission signal transmitted to the k-th UE, hₖ may denote a matrix representing channels between the k-th UE and the plurality of base stations 130_1 to 130_M, and C_{q} may denote a covariance matrix of q, which is a matrix generated by using q₁ to qₘ as components. Here, since a data rate Dₖ of the k-th UE is proportional to SINRₖ, maximization of the minimum value of data rates D₁ to Dₖ of the plurality of UE 140_1 to 140_K may be identical to maximization of the minimum value of SINR₁ to SINRₖ.

Based on the above-stated matters, SINRₖ, a transmission power Pₘ, and a codebook parameter Cₘ is expressed as a function regarding a transmission power coefficient n and a codebook parameter σ may be expressed as Equations 7 to 9 below.

$$[ Equation 7 ]$$

$$SIN {R}_{k} ( η , σ ) = \frac{{( 1 - ρ )}^{2} {η}_{k}}{ρ ( 1 - ρ ) {h}_{k}^{H} diag ( F η {F}^{H} ) {h}_{k} + ( 1 - ρ ) {h}_{k}^{H} ( {σ}^{2} ⊗ I ) {h}_{k} + {σ}^{2}}$$

$$[ Equation 8 ]$$

$${P}_{m} ( η , {σ}_{m} ) = {( 1 - ρ )}^{2} tr ( {W}_{m} {F}_{m} η {F}_{m}^{H} {W}_{m}^{H} ) + ρ ( 1 - ρ ) tr ( {W}_{m} diag ( {F}_{m} η {F}_{m}^{H} ) {W}_{m}^{H} ) + ( 1 - ρ ) {σ}_{m}^{2} tr ( {W}_{m} {W}_{m}^{H} )$$

$${C}_{m} ( η , {σ}_{m} ) = {log}_{2} det ( I + \frac{1}{{σ}_{m}^{2}} {F}_{m} η {F}_{m}^{H} ) \qquad [ Equation 9 ]$$

In Equations 7 to 9, F may denote a matrix representing linear precoders between the plurality of base stations 130_1 to 130_M and the plurality of UE 140_1 to 140_K, and Fₘ may denote a matrix representing liner precoders between the m-th base station and the plurality of UE 140_1 to 140_K.

Here, the central control device 110 may calculate a transmission power coefficient and a codebook parameter to maximize the minimum data rate of each of the plurality of UE 140_1 to 140_K and limit the transmission power of the plurality of base stations 130_1 to 130_M to be less than or equal to a transmission power limit and satisfy a fronthaul capacity limit by processing an equation like Equation 10 below.

$${max}_{η \geq 0 , σ \geq 0} ( {min}_{k} SIN {R}_{k} ) \qquad [ Equation 10 ]$$

$$subject to$$

$${P}_{m} \leq P ,$$

$${C}_{m} \leq C$$

In Equation 10, the central control device 110 may calculate the transmission power coefficient η and the codebook parameter σ by repeating calculation of the transmission power coefficient η while the codebook parameter σ is fixed and calculation of the codebook parameter σ while the transmission power coefficient η is fixed.

According to an embodiment, the central control device 110 may calculate the transmission power coefficient η while the codebook parameter σ is fixed, by using a bisection method and a convex solver.

In detail, first, the central control device 110 may set a minimum comparison value using the bisection method. Here, the minimum comparison value is a value to be compared with the minimum value of SINRₖ and may be expressed as t in Equation 11 below.

Next, the central control device 110 may fix the codebook parameter σ. Here, in an example in which there is a pre-calculated codebook parameter σ, the central control device 110 may fix the pre-calculated codebook parameter σ as the codebook parameter σ. To the contrary, in an example in which there is no pre-calculated codebook parameter σ, the central control device 110 may fix a pre-set initial codebook parameter as the codebook parameter σ.

Next, the central control device 110 may calculate the transmission power coefficient η by processing Equation 11 below.

$$find \qquad [ Equation 11 ]$$

$$η \geq 0$$

$$subject to$$

$$SIN {R}_{k} \geq t ,$$

$${P}_{m} \leq P ,$$

$${C}_{m} \leq C$$

Here, the central control device 110 may calculate the transmission power coefficient η by processing Equation 11 above by using the convex solver.

According to an embodiment, the central control device 110 may calculate the codebook parameter σ while the transmission power coefficient η is fixed by processing Equation 12 below.

$${C}_{m} ( η , {σ}_{m} ) = {log}_{2} det ( I + \frac{1}{{σ}_{m}^{2}} {F}_{m} η {F}_{m}^{H} ) = C \qquad [ Equation 12 ]$$

Here, the central control device 110 may process Equation 12 while the transmission power coefficient η, which is calculated while the codebook parameter σ was fixed, is fixed, thereby calculating the codebook parameter σ.

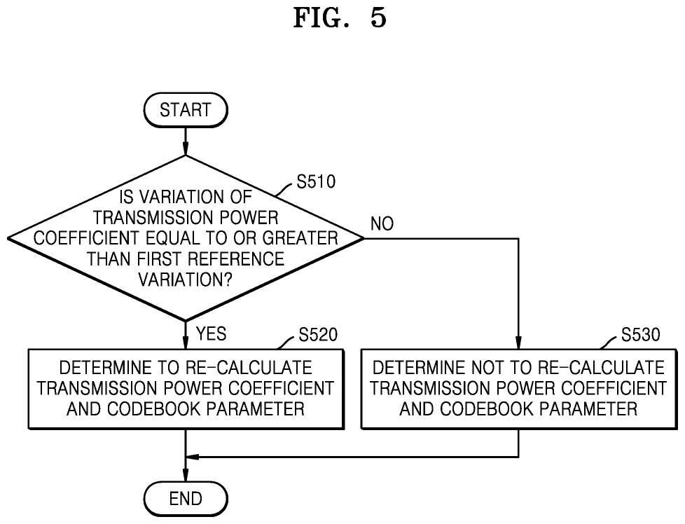

After calculating the codebook parameter σ two or more times, the central control device 110 may determine whether to re-calculate the transmission power coefficient η and the codebook parameter σ based on at least one of the variation of the transmission power coefficient η and the variation of the codebook parameter σ. A method for the central control device 110 to determine whether to re-calculate the transmission power coefficient η and the codebook parameter σ will be described later with reference to FIGS. 5 to 7.

The central control device 110 may generate the transmission signal pₘ after completing the calculation of the transmission power coefficient η and the codebook parameter σ. The central control device 110 may generate the transmission signal pₘ based on the data signal sₖ, the transmission power coefficient η, and a linear precoder. Here, the central control device 110 may generate the transmission signal pₘ by using Equation 1 above.

The central control device 110 may transmit the transmission signal pₘ to the plurality of base stations 130_1 to 130_M through the fronthaul 120.

The fronthaul 120 may transmit the transmission signal pₘ input from the central control device 110 to the plurality of base stations 130_1 to 130_M. Here, the fronthaul 120 may generate the fronthaul noise dₘ corresponding to the codebook parameter σ. The fronthaul noise dₘ may be noise generated when the transmission signal pₘ is compressed through a codebook and transmitted through the fronthaul 120. Here, the fronthaul noise dₘ may be modeled as a Gaussian function having an average of 0 and a variance proportional to the square of the codebook parameter σ. However, the disclosure is not limited thereto, and as such, according to another embodiment, the fronthaul noise dₘ may be modeled in a different manner. For example, the fronthaul noise dₘ may be modeled or obtained using another function.

According to an embodiment, each of the plurality of base stations 130_1 to 130_M may receive the transmission signal pₘ to which the fronthaul noise dₘ is added from the fronthaul 120.

According to an embodiment, each of the plurality of base stations 130_1 to 130_M may quantize the transmission signal pₘ, which is received through the fronthaul 120. Here, each of the plurality of base stations 130_1 to 130_M may quantize the transmission signal pₘ added with fronthaul noise dₘ. According to an embodiment, each of the plurality of base stations 130_1 to 130_M may generate a quantized transmission signal xₘ by using Equation 4 above. The plurality of base stations 130_1 to 130_M may transmit the quantized transmission signal xₘ to the plurality of UE 140_1 to 140_K.

In an example in which the central control device 110 of the communication system 100 according to the disclosure as described above is used, a high data rate may be provided to the plurality of UE 140_1 to 140_K by calculating the transmission power coefficient η and the codebook parameter σ, such that the transmission power Pₘ of the plurality of base stations 130_1 to 130_M is less than or equal to a transmission power limit P and satisfies the fronthaul capacity limit, and transmitting the transmission signal pₘ to the plurality of base stations 130_1 to 130_M through the fronthaul 120.

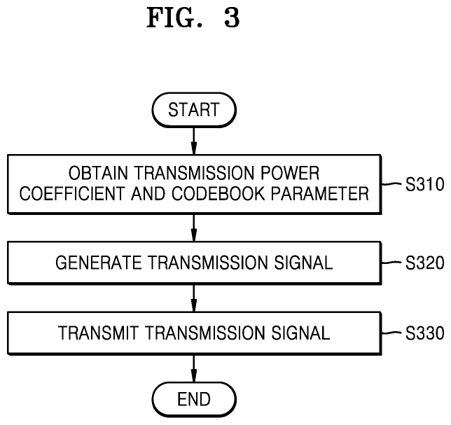

FIG. 3 is a flowchart of a method of operating a central control device, according to an embodiment.

Referring to FIG. 3, in operation S310, the central control device 110 may obtain a transmission power coefficient and a codebook parameter.

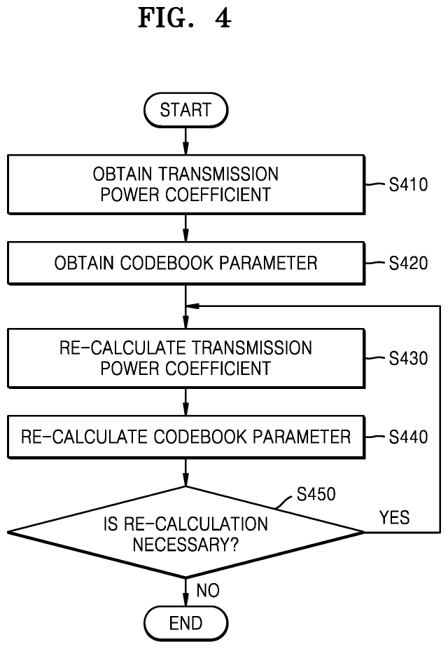

According to an embodiment, the central control device 110 may obtain the transmission power coefficient and codebook parameters by using Equations 10 to 12 above. For example, the central control device 110 may calculate the transmission power coefficient and the codebook parameter by repeating calculation of the transmission power coefficient while the codebook parameter is fixed and calculation of the codebook parameter while the transmission power coefficient is fixed. A more detailed method, by the central control device 110, of calculating the transmission power coefficient and the codebook parameter, will be described later with reference to FIG. 4.

In operation S320, the central control device 110 may generate a transmission signal. The central control device 110 may generate the transmission signal using the transmission power coefficient calculated in operation S310. Here, the central control device 110 may generate the transmission signal by using Equation 1 above.

In operation S330, the central control device 110 may transmit the transmission signal. The central control device 110 may transmit the transmission signal generated in operation S320 to the plurality of base stations 130_1 to 130_M through the fronthaul 120.

FIG. 4 is a flowchart of a method, by a central control device, of calculating a transmission power coefficient and a codebook parameter, according to an embodiment.

Referring to FIG. 4, in operation S410, the central control device 110 may obtain a transmission power coefficient. The central control device 110 may obtain the transmission power coefficient while a codebook parameter is fixed according to Equation 10 above.

According to an embodiment, the central control device 110 may calculate the transmission power coefficient for the first time, and may not yet have calculated a codebook parameter. For example, the central control device 110 may calculate the transmission power coefficient prior to (or before) calculating a codebook parameter. Therefore, since there is no pre-calculated codebook parameter, the central control device may fix a pre-set initial codebook parameter as the codebook parameter. Also, the central control device 110 may calculate the transmission power coefficient by using the initial codebook parameter as the codebook parameter.

In operation S420, the central control device 110 may obtain the codebook parameter. The central control device 110 may calculate the codebook parameter while the transmission power coefficient is fixed, according to Equation 10 above. Here, the central control device 110 may calculate the codebook parameter by using the transmission power coefficient calculated in operation S410.

In operation S430, the central control device 110 may re-calculate the transmission power coefficient. Here, in an example in which operation S430 is performed following operation S420, the central control device 110 may re-calculate the transmission power coefficient by using the codebook parameter calculated in operation S420. In an example in which operation S430 is performed following operation S450 described below, the central control device 110 may re-calculate the transmission power coefficient by using the codebook parameter calculated in operation S430 performed previously.

In operation S440, the central control device 110 may re-calculate the codebook parameter. The central control device 110 may re-calculate the codebook parameter by using the transmission power coefficient calculated in operation S430.

In operation S450, the central control device 110 may determine whether the transmission power coefficient and the codebook parameter need to be re-calculated. In other words, the central control device 110 may determine whether it is necessary to additionally adjust the transmission power coefficient and the codebook parameter and determine whether the transmission power coefficient and codebook parameter need to be re-calculated. A more detailed method, by the central control device 110, of determining whether the transmission power coefficient and the codebook parameter need to be re-calculated, will be described later with reference to FIGS. 5 to 7.

In an example in which it is determined that the transmission power coefficient and the codebook parameter need to be re-calculated, the method may proceed to operation S430, and the central control device 110 may re-calculate the transmission power coefficient and the codebook parameter.

In an example in which it is determined that re-calculation of the transmission power coefficient and codebook parameter is not necessary, the central control device 110 may terminate the calculation of the transmission power coefficient and codebook parameter.

FIG. 5 is a flowchart of a first example of a method, by a central control device, of determining whether a transmission power coefficient and a codebook parameter need to be re-calculated, according to an embodiment.

Referring to FIG. 5, a method, by the central control device 110, of determining whether the transmission power coefficient and the codebook parameter need to be re-calculated based on the variation of the transmission power coefficient may be confirmed.

In operation S510, the central control device 110 may determine whether the variation of the transmission power coefficient is equal to or greater than a first reference variation.

The variation of the transmission power coefficient may refer to the variation between the most recently calculated transmission power coefficient and a transmission power coefficient calculated therebefore. The first reference variation is a reference value for determining whether the variation of the transmission power coefficient is large, and, when the variation of the transmission power coefficient is equal to or greater than the first reference variation, the central control device 110 may determine that the transmission power coefficient and the codebook parameter need to be additionally calculated. For example, the first reference variation may be 1%, but the disclosure is not limited thereto.

In an example in which the variation of the transmission power coefficient is equal to or greater than the first reference variation, in operation S520, the central control device 110 may determine to re-calculate the transmission power coefficient and the codebook parameter.

On the other hand, in an example in which the variation of the transmission power coefficient is less than the first reference variation, in operation S530, the central control device 110 may determine not to re-calculate the transmission power coefficient and the codebook parameter.

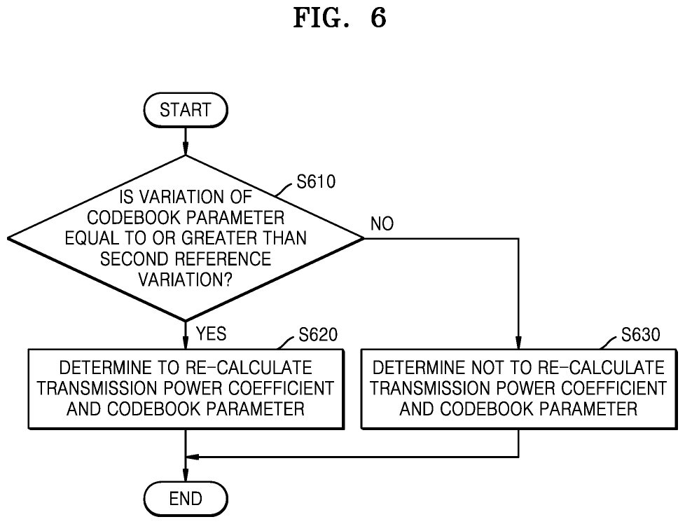

FIG. 6 is a flowchart of a second example of a method, by a central control device, of determining whether a transmission power coefficient and a codebook parameter need to be re-calculated, according to an embodiment.

Referring to FIG. 6, a method, by the central control device 110, of determining whether the transmission power coefficient and the codebook parameter need to be re-calculated based on the variation of the codebook parameter may be confirmed. In operation S610, the central control device 110 may determine whether the variation of the codebook parameter is equal to or greater than a second reference variation.

The variation of the codebook parameter may refer to the variation between the most recently calculated codebook parameter and a codebook parameter calculated therebefore. The second reference variation is a reference value for determining whether the variation of the codebook parameter is large, and, when the variation of the codebook parameter is equal to or greater than the first reference variation, the central control device 110 may determine that the transmission power coefficient and the codebook parameter need to be additionally calculated. For example, the second reference variation may be 1%, but the disclosure is not limited thereto.

In an example in which the variation of the codebook parameter is equal to or greater than the second reference variation, in operation S620, the central control device 110 may determine to re-calculate the transmission power coefficient and the codebook parameter.

On the other hand, in an example in which the variation of the codebook parameter is less than the second reference variation, in operation S630, the central control device 110 may determine not to re-calculate the transmission power coefficient and the codebook parameter.

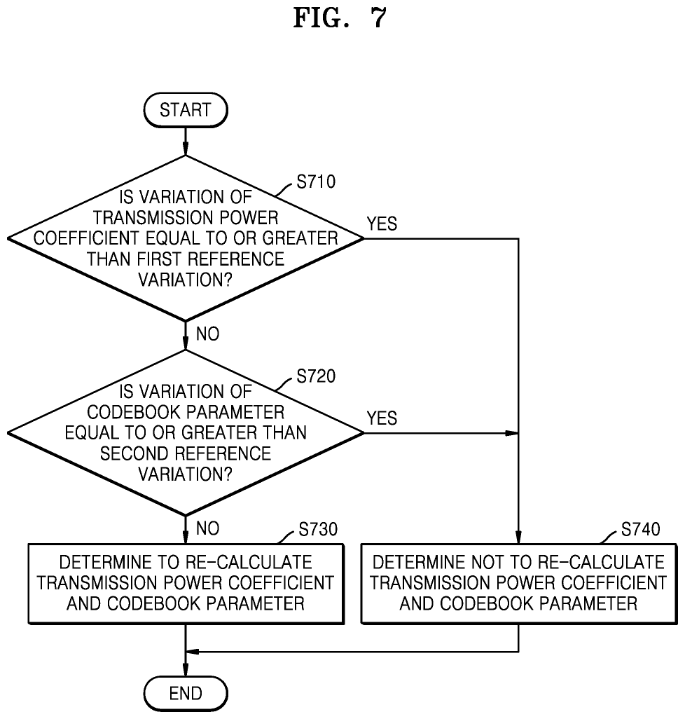

FIG. 7 is a flowchart of a third example of a method, by a central control device, of determining whether a transmission power coefficient and a codebook parameter need to be re-calculated, according to an embodiment.

Referring to FIG. 7, a method, by the central control device 110, of determining whether the transmission power coefficient and the codebook parameter need to be re-calculated based on both the variation of the transmission power coefficient and the variation of the codebook parameter may be confirmed.

In operation S710, the central control device 110 may determine whether the variation of the transmission power coefficient is equal to or greater than a first reference variation.

In an example in which the variation of the transmission power coefficient is equal to or greater than the first reference variation, in operation S740, the central control device 110 may determine to re-calculate the transmission power coefficient and the codebook parameter. In other words, the central control device 110 may determine to re-calculate the transmission power coefficient and the codebook parameter regardless of the variation of the codebook parameter when the variation of the transmission power coefficient is equal to or greater than the first reference variation.

On the other hand, in an example in which the variation of the transmission power coefficient is less than the first reference variation, in operation S720, the central control device 110 may determine whether the variation of the codebook parameter is equal to or greater than the second reference variation.

In an example in which the variation of the codebook parameter is equal to or greater than the second reference variation, in operation S740, the central control device 110 may determine to re-calculate the transmission power coefficient and the codebook parameter. In other words, the central control device 110 may determine to re-calculate the transmission power coefficient and the codebook parameter regardless of the variation of the transmission power coefficient when the variation of the codebook parameter is equal to or greater than the second reference variation.

In an example in which the variation of the codebook parameter is less than the second reference variation, in operation S730, the central control device 110 may determine not to re-calculate the transmission power coefficient and the codebook parameter. In other words, the central control device 110 may determine to re-calculate the transmission power coefficient and the codebook parameter regardless of the variation of the transmission power coefficient only when the variation of the transmission power coefficient is less than the first reference variation and the variation of the codebook parameter is less than the second reference variation.

In an example in which the method of controlling the central control device 110 according to the disclosure as described above is used, a high data rate may be provided to the plurality of UE 140_1 to 140_K by calculating a transmission power coefficient and a codebook parameter, such that the transmission power of the plurality of base stations 130_1 to 130_M is less than or equal to a transmission power limit and satisfies a fronthaul capacity limit, and transmitting a transmission signal to the plurality of base stations 130_1 to 130_M through the fronthaul 120.

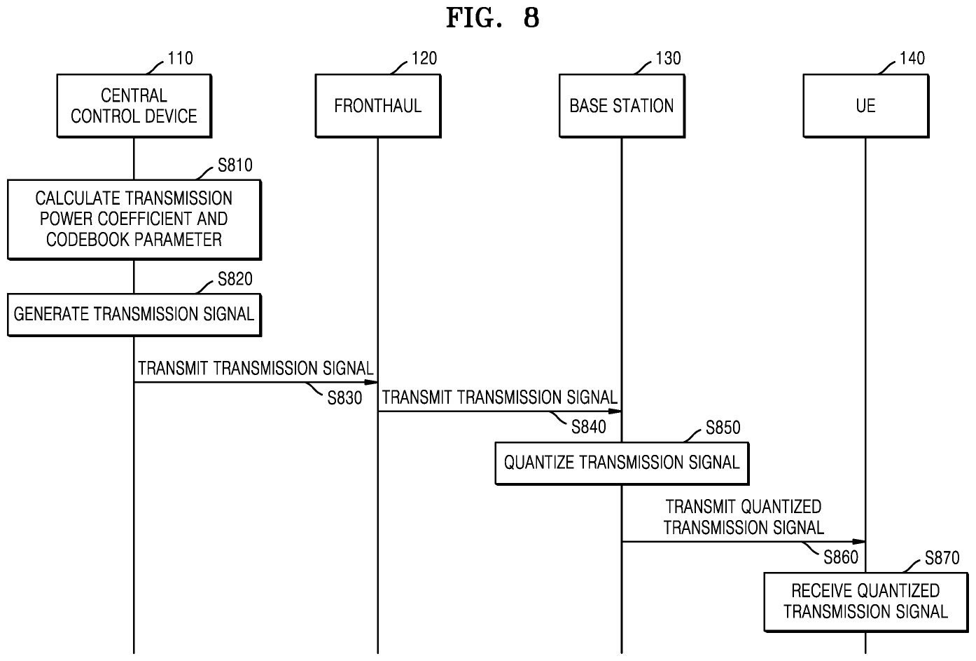

FIG. 8 is a flowchart of a method of operating a communication system, according to an embodiment.

Referring to FIG. 8, in operation S810, the central control device 110 may calculate a transmission power coefficient and a codebook parameter. The central control device 110 may calculate the transmission power coefficient and codebook parameters by using Equations 10 to 12 above.

In operation S820, the central control device 110 may generate a transmission signal. The central control device 110 may generate the transmission signal using the transmission power coefficient calculated in operation S810.

In operation S830, the central control device 110 may transmit a transmission signal to the fronthaul 120. The central control device 110 may transmit the transmission signal generated in operation S820 to the fronthaul 120.

In operation S840, the fronthaul 120 may transmit a transmission signal to a base station 130. The fronthaul 120 may transmit the transmission signal received in operation S830 to the base station 130. Here, fronthaul noise may be added to the transmission signal.

In operation S850, the base station 130 may quantize the transmitted signal. The base station 130 may generate a quantized transmission signal by quantizing the transmission signal, which the fronthaul noise is added to and is received through the fronthaul 120.

In operation S860, the base station 130 may transmit a quantized transmission signal to a UE 140. The base station 130 may transmit the quantized transmission signal to the UE 140 by using an antenna included in the base station 130.

In operation S870, the UE 140 may receive the quantized transmission signal.

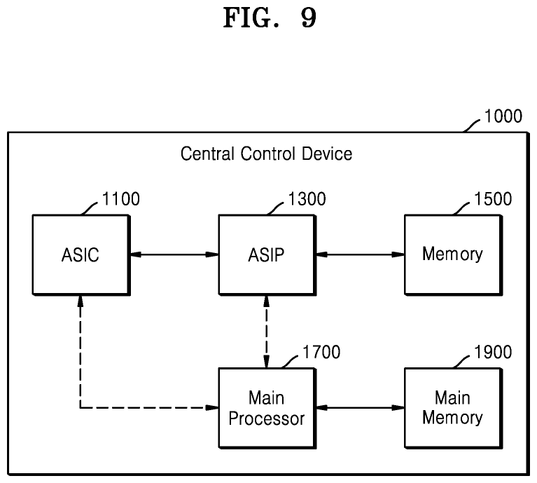

FIG. 9 is a block diagram showing a central control device according to an embodiment.

Referring to FIG. 9, a central control device 1000 may include an application specific integrated circuit (ASIC) 1100, an application specific instruction set processor (ASIP) 1300, a memory 1500, a main processor 1700, and a main memory 1900. Two or more of the ASIC 1100, the ASIP 1300, and the main processor 1700 may communicate with each other (one another). Also, at least two of the ASIC 1100, the ASIP 1300, the memory 1500, the main processor 1700, and the main memory 1900 may be embedded in one chip.

The ASIP 1300 is an integrated circuit customized for a particular purpose, may support a dedicated instruction set for a particular application, and execute instructions included in the instruction set. The memory 1500 may communicate with the ASIP 1300 and may be a non-volatile storage device that stores a plurality of instructions to be executed by the ASIP 1300. For example, the memory 1500 may include any type of memory accessible by the ASIP 1300, which may be, but is not limited to, a random access memory (RAM), a read only memory (ROM), a tape, a magnetic disk, an optical disk, a volatile memory, a non-volatile memory, and a combination thereof.

The main processor 1700 may control the central control device 1000 by executing a plurality of instructions. For example, the main processor 1700 may control the ASIC 1100 and the ASIP 1300, process received data, or process an user input regarding the central control device 1000. The main memory 1900 may communicate with the main processor 1700 and may be a non-volatile storage device that stores a plurality of instructions to be executed by the main processor 1700. For example, the main memory 1900 may include any type of memory accessible by the main processor 1700, which may be, but is not limited to, a random access memory (RAM), a read only memory (ROM), a tape, a magnetic disk, an optical disk, a volatile memory, a non-volatile memory, and a combination thereof.

The method of operating the central control device 110 according to an embodiment described above with reference to FIGS. 1 to 8 may be performed by at least one of components included in the central control device 1000 of FIG. 9. According to some embodiments, at least one operation of the method of operating the central control device 1000 described above may be implemented as a plurality of instructions stored in the memory 1500. According to some embodiments, the ASIP 1300 may perform at least one of operations of the above method by executing a plurality of instructions stored in the memory 1500.

While the disclosure has been particularly shown and described with reference to embodiments thereof, it will be understood that various changes in form and details may be made therein without departing from the spirit and scope of the following claims.

What is claimed is:

1. A method of operating a control device, the method comprising:
obtaining a transmission power coefficient and a codebook parameter based on a data rate of each of a plurality of user equipment, a transmission power of a plurality of base stations and a fronthaul capacity limit;
generating a transmission signal based on the transmission power coefficient; and
transmitting the transmission signal to the plurality of base stations through a fronthaul.

2. The method of claim 1, wherein the obtaining the transmission power coefficient and the codebook parameter comprises:
calculating the transmission power coefficient based on an initial codebook parameter; and
calculating the codebook parameter based on the calculated transmission power coefficient,
wherein the transmission power coefficient and the codebook parameter are calculated by maximizing a minimum value of the data rate of each of the plurality of user equipment, and limiting the transmission power of the plurality of base stations to be is less than or equal to a transmission power limit and satisfy the fronthaul capacity limit.

3. The method of claim 2, wherein the obtaining the transmission power coefficient comprises:
setting a minimum comparison value by using a bisection method; and
calculating the transmission power coefficient by using the minimum comparison value and a convex solver.

4. The method of claim 2, wherein the obtaining the transmission power coefficient and the codebook parameter further comprises:
re-calculating the transmission power coefficient based on the calculated codebook parameter; and
re-calculating the codebook parameter based on the re-calculated transmission power coefficient.

5. The method of claim 4, wherein the obtaining the transmission power coefficient and the codebook parameter comprises, after re-calculating the codebook parameter, determining whether to re-perform the calculating of the transmission power coefficient and the calculating of the codebook parameter based on at least one of a variation of the transmission power coefficient due to the re-calculating of the transmission power coefficient and a variation of the codebook parameter due to the re-calculating of the codebook parameter.

6. The method of claim 5, wherein the determining of whether to re-perform the calculating of the transmission power coefficient and the calculating of the codebook parameter comprises:
determining to re-perform the re-calculating of the transmission power coefficient and the re-calculating of the codebook parameter based on the variation of the transmission power coefficient being equal to or greater than a first reference variation; and
determining not to re-perform the re-calculating of the transmission power coefficient and the re-calculating of the codebook parameter based on the variation of the transmission power coefficient being less than the first reference variation.

7. The method of claim 5, wherein the determining of whether to re-perform the calculating of the transmission power coefficient and the calculating of the codebook parameter comprises:
determining to re-perform the re-calculating of the transmission power coefficient and the re-calculating of the codebook parameter based on the variation of the codebook parameter being equal to or greater than a second reference variation; and
determining not to re-perform the re-calculating of the transmission power coefficient and the re-calculating of the codebook parameter based on the variation of the codebook parameter being less than the second reference variation.

8. The method of claim 5, wherein the determining of whether to re-perform the calculating of the transmission power coefficient and the calculating of the codebook parameter comprises:
determining to re-perform the re-calculating of the transmission power coefficient and the re-calculating of the codebook parameter based on the variation of the transmission power coefficient being equal to or greater than a first reference variation or the variation of the codebook parameter being equal to or greater than a second reference variation; and
determining not to re-perform the re-calculating of the transmission power coefficient and the re-calculating of the codebook parameter based on the variation of the transmission power coefficient being less than the first reference variation and the variation of the codebook parameter being less than the second reference variation.

9. The method of claim 1, wherein the transmission signal is generated based on a data signal to be transmitted to each of the plurality of user equipment, the obtained transmission power coefficient, and a linear precoder.

10. The method of claim 1, wherein the transmission signal is transmitted to the plurality of base stations through the fronthaul generating fronthaul noise corresponding to the codebook parameter.

11. A control device comprising:
at least one memory storing one or more instructions; and
at least one processor configured to execute the one or more instructions:
obtain a transmission power coefficient and a codebook parameter based on a data rate of each of a plurality of user equipment, a transmission power of a plurality of base stations and a fronthaul capacity limit;
generate a transmission signal based on the transmission power coefficient; and
transmit the transmission signal to the plurality of base stations through a fronthaul.

12. The control device of claim 11, wherein the at least one processor further configured to:
set a minimum comparison value by using a bisection method; and
calculate the transmission power coefficient by using the minimum comparison value and a convex solver.

13. The control device of claim 11, wherein the at least one processor further configured to:
calculate the transmission power coefficient based on an initial codebook parameter; and
calculate the codebook parameter based on the calculated transmission power coefficient.

14. The control device of claim 13, wherein the at least one processor further configured to:
re-calculate the transmission power coefficient based on the calculated codebook parameter; and
re-calculate the codebook parameter based on the re-calculated transmission power coefficient.

15. The control device of claim 14, wherein the at least one processor further configured to, after re-calculating the codebook parameter, determine whether to re-calculate the transmission power coefficient and the codebook parameter based on at least one of a variation of the transmission power coefficient due to the re-calculating of the transmission power coefficient and a variation of the codebook parameter due to the re-calculating of the codebook parameter.

16. The control device of claim 11, wherein the transmission signal is generated based on a data signal to be transmitted to each of the plurality of user equipment, the obtained transmission power coefficient, and a linear precoder.

17. The control device of claim 11, wherein the transmission signal is transmitted to the plurality of base stations through the fronthaul generating fronthaul noise corresponding to the codebook parameter.

18. The control device of claim 17, wherein the transmission power coefficient and the codebook parameter are calculated by maximizing a minimum value of the data rate of each of the plurality of user equipment, and limiting the transmission power of the plurality of base stations to be is less than or equal to a transmission power limit and satisfy the fronthaul capacity limit.

19. A method of operating a communication system including a central control device, a fronthaul, and a plurality of base stations, the method comprising:
obtaining, by the central control device, a transmission power coefficient and a codebook parameter based on a data rate of each of a plurality of user equipment is maximized, a transmission power of the plurality of base stations and a fronthaul capacity limit;
generating, by the central control device, a transmission signal based on the transmission power coefficient;
transmitting, by the central control device, the transmission signal to the plurality of base stations through the fronthaul generating fronthaul noise corresponding to the codebook parameter;
quantizing, by each of the plurality of base stations, the transmission signal received through the fronthaul; and
transmitting, by the plurality of base stations, the quantized transmission signal to the plurality of user equipment, respectively.

20. The method of claim 19, wherein the obtaining of the transmission power coefficient and the codebook parameter comprises:
calculating the transmission power coefficient based on an initial codebook parameter;
calculating the codebook parameter based on the calculated transmission power coefficient;
re-calculating the transmission power coefficient based on the calculated codebook parameter;
re-calculating the codebook parameter based on the re-calculated transmission power coefficient; and,
after re-calculating the codebook parameter, determining whether to re-perform the calculating of the transmission power coefficient and the calculating of the codebook parameter based on at least one of a variation of the transmission power coefficient due to the re-calculating of the transmission power coefficient and a variation of the codebook parameter due to the re-calculating of the codebook parameter,
wherein the transmission power coefficient and the codebook parameter are calculated by maximizing a minimum value of the data rate of each of the plurality of user equipment, and limiting the transmission power of the plurality of base stations to be is less than or equal to a transmission power limit and satisfy the fronthaul capacity limit.
